(19) United States
(12) Patent Application Publication
(10) Pub. No.: US 2007/0176057 A1
(43) Pub. Date: Aug. 2, 2007

(54) Hanger System for Rigid Lines

(75) Inventor: David Sharman, Newburgh, IN (US)

Correspondence Address: C RICHARD MARTIN;MARTIN & MARTIN, PO BOX 29, BOONVILLE, IN, 47601, US

(73) Assignee: ELECTRONICS RESEARCH, INC., Chandler, IN (US)

(21) Appl. No.: 11/307,236

(22) Filed: Jan. 27, 2006

(51) Int. Cl. F16L 3/08

(52) U.S. Cl. 248/65

(57) ABSTRACT

A hanger for supporting a rigid line. The hanger having a bracket with a means for supporting a pair of, for example, plastic guides rotatable between a first position and a second position. The guides accepting the lateral insertion of the rigid line between them in the first position and restraining the rigid line from lateral movement in a second position. A retainer link operating to maintain the rigid line between the guides when in the first position and to lock the guide retainers into place when in the second position.

### BACKGROUND

1. Field of the Invention

This invention relates to a hanger system for rigid lines and more particularly to a hanger system for rigid lines with multiple line diameter capability, manufacturing cost efficiencies and improved installation and service characteristics.

2. Description of Related Art

Rigid lines, for example process piping or waveguides, are supported by hanger systems. A number of problems have been recognized when long rigid line runs are to be supported. For example, a typical RF transmission tower may vary in height from a few hundred to more than 1500 feet. A vertical run of a rigid line in the form of, for example, a circular, oval or square waveguide corresponding to the tower height must be erected and supported in the tower. Since the tower is made of steel and the waveguide is made of aluminum or copper, the waveguide tends to creep axially relative to the tower due to differential expansion accompanying changes in temperature. The waveguide is further subject to severe lateral forces due to wind loading, tending to deform it at the points of support. The likelihood of deformation is increased because the waveguide may have a sidewall of relatively soft metal that is thin in relation to its diameter. Such deformation tends to introduce discontinuities into energy modes transmitted through the waveguide, resulting in degraded electrical performance.

Prior rigid line hanger systems have a connection between the support structure and an oversized guide clamp to which a support clamp is connected by a spring element to compensate for the differential expansion rates between the support structure and the rigid line. Axially movable in the guide clamp, the rigid line is supported by the support clamp via the spring.

Such prior systems have a number of disadvantages. Among these is the relative complexity of the numerous unique metal components comprising the clamps and interconnecting hardware that must be separately fabricated for each desired rigid line configuration. Also, seemingly simple mechanical operations are made much more difficult when they must be performed in exposed locations such as high atop a radio tower. The prior hanger systems use clamps that need to be partially dismantled to open or close the hanger during rigid line installation and or service because each clamp needs to be close fitted around the rigid line and at least one bolt and nut threaded while the clamp and rigid line is also held in place. Further, to prevent damage from metal to metal contact between the guide clamp and the rigid line an additional plurality of plastic buttons is used to line the guide clamp contact surfaces of the prior hanger systems, adding to manufacturing materials and assembly costs, and which provide a limited contact area thereby increasing the potential for rigid line deformation under high wind conditions. Other designs, in which the components are not normally removed, require a large space, to accommodate opening the clamp, which may not be readily available in the confines of the supporting structure. Another problem is the potential danger of hanger components being dropped from great heights.

Competition within the rigid line hanger system industry has focused attention on structural integrity, materials and manufacturing operations costs. Also, ease of installation and service is a growing consideration in the hanger system market.

Therefore, it is an object of the invention to provide an apparatus that overcomes deficiencies in the prior art.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a schematic side view of a first embodiment of the invention.

FIG. 2 is a schematic top view of the guide clamp assembly of FIG. 1, configured for 4″ diameter circular rigid line.

FIG. 3 is a schematic section end view, along line AA of FIG. 2, of the guide clamp retainers, other structure omitted.

FIG. 4 is a schematic end view of a swing retention link.

FIG. 5 is a schematic top view of the guide clamp assembly, of FIG. 2, configured for 3″ diameter circular rigid line.

### DETAILED DESCRIPTION

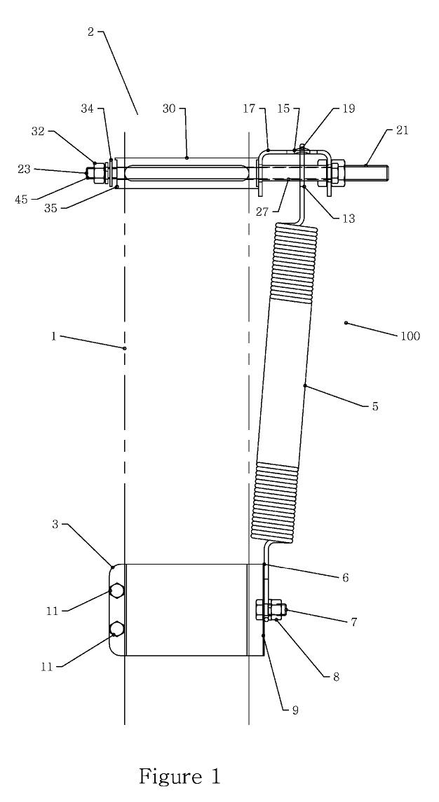

As shown in FIG. 1, a rigid line hanger 100 according to a first embodiment of the invention supports a rigid line 1 via a guide clamp assembly 2 coupled to a support clamp 3 by a spring 5. The spring 5 is secured at a first end 6 to the support clamp 3 via, for example, a spring bolt 7 and spring nut 8 connection to a spine 9 of the support clamp 3. The support clamp 3 may be secured to the rigid line 1 by one or more support clamp bolt(s) 11. Alternatively, the support clamp 3 may be any form of secure clamp, bracket or an existing connection point on the rigid line 1 for the first end of the spring 5.

The spring 5 is attached at a second end 13 to the guide clamp assembly 2. The spring 5 attachment to the guide clamp assembly 2 may be, for example, via a hook formed in the second end 13 of the spring 5 that is looped through a pair of spring hole(s) 15 in a bracket 17. A spring mating surface 19 between the spring holes 15 may be machined or stamped to present a shaped surface so that the spring 5 does not seat against sharp edges. The spring hole(s) 15 may be formed as slots. If slots are used, a retainer such as a bolt and nut or a plastic grommet and screw may be inserted into the slot. Alternatively, the second end 13 of the spring 5 may be attached with a fastener to the flange of bracket 17.

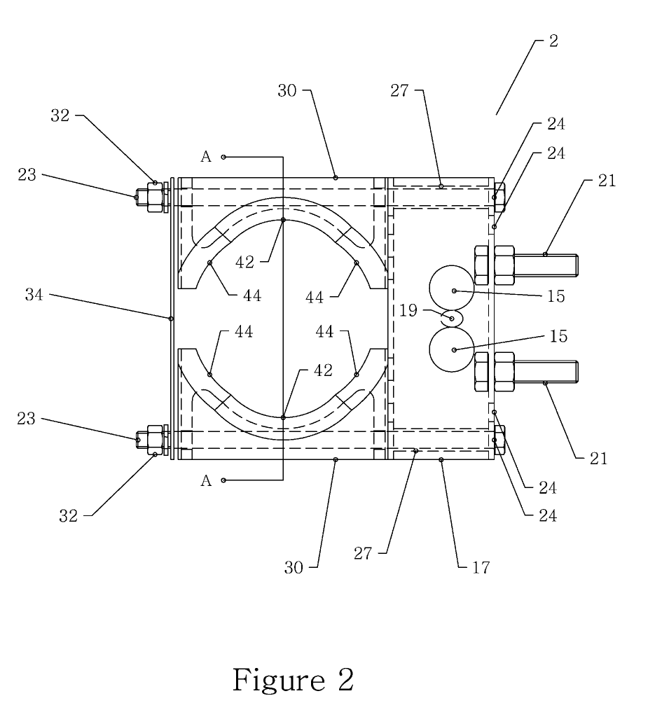

As shown in FIG. 2, the guide clamp assembly 2 is mountable to a desired support structure via, for example, one or more attachment bolt(s) 21 fitted through attachment holes in the bracket 17. The bracket 17 may be formed, for example, from commonly available steel or other metal alloy U-channel stock.

Hinge pin(s) 23 with a threaded end 45 are fitted through hinge pin hole(s) 24 in both sides of the bracket 17. Sleeve(s) 27 may be inserted over the hinge pin(s) 23 at the interior of the bracket 17, to prevent deformation of the U-channel of the bracket 17 as the hinge pins(s) 23 are secured. Each hinge pin 23 operates as a support for a guide 30. Alternatively, the hinge pin(s) 23 may be replaced with bolts, tubes, rods, studs, carriage bolts or any other supporting means which supports the guide(s) 30 in a parallel orientation with respect to each other.

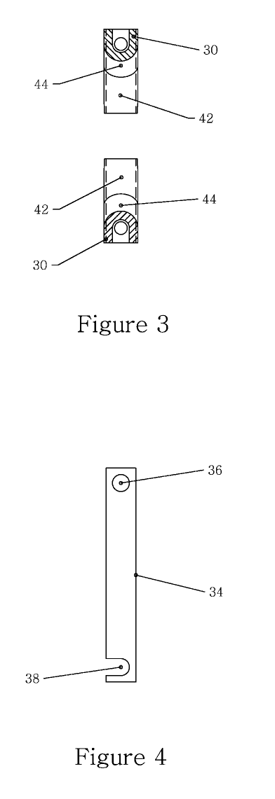

The guide(s) 30, as shown in FIG. 3, are formed to cooperatively retain the rigid line 1 between them, allowing movement along a longitudinal axis of the rigid line 1 and a minimum of lateral movement. To prevent potentially damaging metal-to-metal contact between the guide clamp assembly 2 and the rigid line 1, the guide(s) 30 may be formed, for example, out of nylon or other plastic material via injection molding. The guide(s) 30 may be retained on the corresponding hinge pin(s) 23 by, for example, hinge pin nut(s) 32. Until the hinge pin nut(s) 32 are tightened, the guide(s) 30 are free to rotate about the hinge pin(s) 23.

A retention link 34, as shown in FIG. 4, may be adapted to cooperate with a retaining element, for example a groove 35, formed along the outside edge of each guide 30 to lock the guide clamp retainer(s) 30 into a co-planar orientation with each other, and a close fit around the rigid line 1. Alternative retaining elements include: small protrusions or detents on the outside edge or elsewhere of the guide(s) 30 that mate with holes formed in the retention link 34; or conversely, lugs, pins or other features on the retention link 34 that mate with and hold the guide(s) 30.

The retention link 34 may be formed with a mounting hole 36 on one end and a slot 38 on the other. The mounting hole 36 secures the retention link 34 to one of the hinge pin(s) 23. While the hinge pin nut(s) 32 are loose, the retention link 34 may be rotated until the slot 38 engages the other hinge pin 23. When the guide(s) 30 are positioned so that the retention link 34 seats into the groove(s) 35, each of the hinge pin nut(s) 32 may be fully tightened and the guide clamp assembly 2 thereby secured about the rigid line 1.

To prevent removal and possible loss of the applicable hinge pin nut(s) 32 (or other applicable retainer), retention link 34 and or guide(s) 30, means to prevent removal of the hinge pin nut(s) 32 and the associated hinge pin(s) 23 may be used. Examples of means to prevent removal include: nylon inserts in the hinge pin nut(s) 32, a hole and split or taper pin, a retainer clip and groove, a split end or other slight deformation of the first few hinge pin 23 threads, and or use of adhesives or spot welding.

During installation, the guide clamp assembly 2 may be mounted to the support structure via the attachment bolt(s) 21. With the hinge pin nut(s) 32 loosened, the guide(s) 30 and retention link 34 may be positioned in an open position so that the rigid line 1 may be installed laterally within the open guide clamp assembly 2, between the guide(s) 30. By swinging the retention link 34 so that the slot 38 engages the other hinge pin 23, the rigid line 1 may be temporarily secured, allowing hands free positioning of the guide(s) 30 into a closed position where the retention link 34 seats into the groove(s) 35. With the rigid line 1 secured, but axially movable, within the guide clamp assembly 2, the support clamp 3 and spring 5 may be installed.

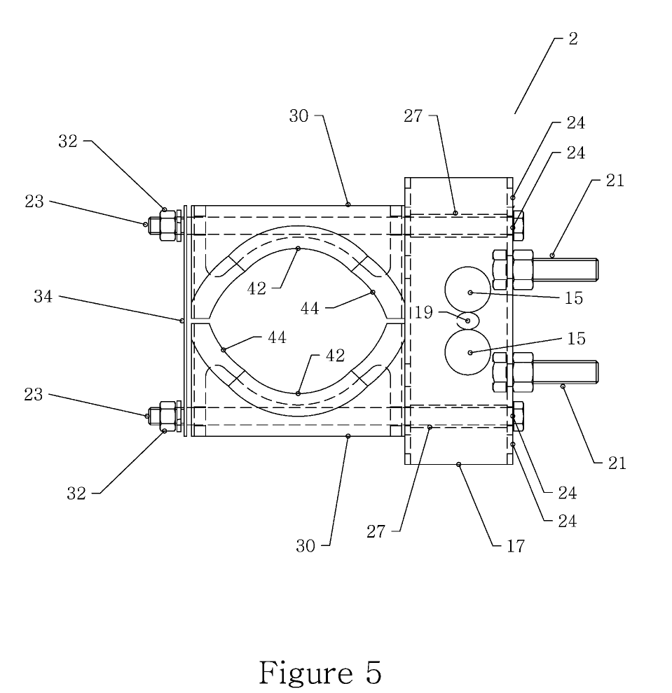

To further increase the range of rigid line dimensions usable with each support clamp assembly 2, a series of differently spaced hinge pin hole(s) 24a, 24b may be made in the bracket 17. As shown for example by FIG. 2, using the outer hinge pin holes 24a, the same guide clamp assembly 2 may be assembled for use with a larger diameter rigid line 1, such as a 4 inch diameter rigid line. Likewise, as shown for example by FIG. 5, using the inner hinge pin holes 24b, the same guide clamp assembly 2 may be assembled for use with a smaller diameter rigid line 1, such as a 3 inch diameter rigid line. More than two sets of hinge pin holes may be used to accommodate rigid lines of varying diameters. In addition, a first dimension 42 specific to a first particular diameter rigid line 1, for example 3 inch radius, and a second dimension 44 specific to a second particular diameter rigid line 1, for example 4 inch radius, may be formed in separate portions of the rigid line contact surface of the guide 30 to form a close tolerance fit against the rigid line 1, in each configuration, to minimize lateral movement of the rigid line 1. Further the first dimension 42 and second dimension 44 may be adapted for rigid lines 1 having different cross sectional shapes. Also, the guide 30 may be formed with alternate surfaces, for example located on the opposite side of the hinge pin 23, to allow use of a single guide 30 with a wide range of different rigid line 1 dimensions and or cross sections.

The present invention may also be used in high density rigid line support configurations via use of an extended bracket that supports a plurality of guide clamp assembly(s) 2 along its length. For highest density, the guide(s) 30 may be formed double sided, each guide 30 contacting and thereby retaining a rigid line 1 located on either side of each hinge pin 23. Alternatively, the hinge pin(s) 23 may be extended and the guide(s) 30 dimensioned for use with multiple, laterally stacked rigid line(s) 1.

One skilled in the art will appreciate that the present invention may be cost effectively fabricated from commonly available materials with a minimum of assembly, metal bending and or machining manufacturing operations. Manufacturing efficiencies are also increased when one appreciates that to mate the support clamp assembly to a range of different rigid line cross sections, for example circular, oval and or square, only the guide(s) 30 need to be exchanged. In other examples, the guide(s) 30 and bracket 17 may be configured to accommodate more than two different sizes and or cross-sections of rigid line. Alternatively, each guide 30 may be formed as a block into which is formed a groove, the groove being a portion or portions of a cone curved about the hinge pin 23 axis of the guide clamp, to accommodate, depending upon the guide 30 position, any of a continuum of rigid line sizes.

The present invention brings to the art a rigid line hanger system formed from commonly available and or inexpensive to manufacture components that may be used with a wide range of different rigid line configurations. Further, the present invention provides a cost efficient rigid line hanger system with heretofore unavailable ease of installation and or service characteristics.

### Table of Parts

The following table provides a description of drawing numbered items.

| | |
|---|---|
| 1 | rigid line |
| 2 | guide clamp assembly |
| 3 | support clamp |
| 5 | spring |
| 6 | first end of spring |
| 7 | spring bolt |
| 8 | spring nut |
| 9 | spine of support clamp |
| 11 | support clamp bolt |
| 13 | second end of spring |
| 15 | spring hole |
| 17 | bracket |
| 19 | spring mating surface |
| 21 | attachment bolt |
| 23 | hinge pin |
| 24a, 24b | hinge pin hole |
| 27 | sleeve |
| 30 | guide |
| 32 | hinge pin nut |
| 34 | retention link |
| 35 | groove |
| 36 | mounting hole |
| 38 | slot |
| 42 | first dimension |
| 44 | second dimension |
| 100 | rigid line hanger |

Where in the foregoing description reference has been made to ratios, integers, components or modules having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

What is claimed is:

1. A guide clamp assembly of a hanger for supporting a rigid line on a support structure comprising:
a bracket having means for removably connecting the guide clamp assembly to the support structure;
a hinge pin inserted through a hinge pin hole in said bracket; and
a guide rotatably supported by said hinge pin between a first position wherein the guide permits the rigid line to be moved in a direction perpendicular to a longitudinal axis of the rigid line, and a second position to restrain the rigid line from movement in directions perpendicular to the longitudinal axis.

2. The guide clamp assembly of claim 1, further comprising:
a second hinge pin inserted through a second hinge pin hole in said bracket; and
a second guide rotatably supported by said second hinge pin between a first position wherein the first and second guides permit the rigid line to be moved in a direction perpendicular to a longitudinal axis of the rigid line, and a second position to restrain the rigid line from movement in directions perpendicular to the longitudinal axis.

3. The guide clamp assembly of claim 2, further including:
a retention element formed in the guides; and
a retention link adapted to couple with each hinge pin and the retention element, thereby retaining the guides in the second position.

4. The guide clamp assembly of claim 3, wherein the retention link has a mounting hole proximate one end and a slot proximate another end; the mounting hole and the slot configured to receive the hinge pins via insertion of the one hinge pin through the mounting hole and rotation of the swing retention link until the slot engages the other hinge pin.

5. The guide clamp assembly of claim 2, wherein each guide conforms to a segment of an outer cross sectional dimension of the rigid line.

6. The guide clamp assembly of claim 5 wherein each guide has a first dimension conforming to a first dimension rigid line and a second dimension conforming to a second dimension rigid line.

7. The guide clamp assembly of claim 1, wherein the bracket is a U-shaped channel.

8. The guide clamp assembly of claim 1, wherein the bracket has a plurality of the hinge pin holes whereby the hinge pin may be arranged to adapt the hanger for use with rigid lines of different diameters.

9. The guide clamp assembly of claim 1, wherein the guide is plastic.

10. The guide clamp assembly of claim 1, further including a support clamp coupled to the bracket by a spring.

11. A hanger for supporting a rigid line on a support structure comprising:
a bracket having means for removably connecting the guide clamp assembly to the support structure;
a pair of guides rotatable between a first position wherein the guides accept the lateral insertion of the rigid line therebetween, and a second position to restrain the rigid line from lateral movement; and
means for supporting said pair of guides on said bracket.

12. The hanger of claim 11, wherein the means for supporting is configurable to change the distance between the guides whereby the hanger is adjustable to accept rigid lines of different diameters.

13. The hanger of claim 11, further including a retention link adapted to mount onto the means for supporting and retaining the guides in the second position.

14. The hanger of claim 13, wherein the retention link is operable to retain the rigid line between the guides when the guide(s) are in the first position.

15. The hanger of claim 11 wherein the guide comprises a plurality of different guide dimensions about its axis of rotation permitting a plurality of choices for the guide used to restrain the rigid line when in the second position.

16. The hanger of claim 11, wherein each guide comprises a block into which is formed a groove, the groove being portions of a cone curved about the hinge axis of the guide clamp, to accommodate, in the second position, any of a continuum of rigid line sizes.

17. The hanger of claim 11, wherein the means for supporting concurrently accepts a plurality of sets of hinge pin(s), guide(s) and retention link(s).

18. The hanger of claim 11, wherein each hinge pin supports one of a guide dimensioned for restraining a plurality of rigid lines and a plurality of guides, each of the plurality of guides dimensioned to restrain a separate rigid line.

19. A hanger for supporting a rigid line on a support structure comprising:
a bracket having means for removably connecting the guide clamp assembly to the support structure;
a hinge pin inserted through a hinge pin hole in said bracket; and
a guide rotatably supported by said hinge pin between a first position wherein the guide permits the rigid line to be moved in a direction perpendicular to a longitudinal axis of the rigid line, and a second position to restrain the rigid line from movement in directions perpendicular to the longitudinal axis; and
a support clamp coupled to the bracket by a spring.
